(19) United States
(12) Patent Application Publication
(10) Pub. No.: US 2005/0078406 A1
(43) Pub. Date: Apr. 14, 2005

(54) Storage unit

(76) Inventor: Andrew Topham, Glos (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/950,808

(22) Filed: Sep. 28, 2004

(30) Foreign Application Priority Data
Oct. 9, 2003 (GB) 0323649.4

(51) Int. Cl. G11B 15/68

(52) U.S. Cl. 360/92

(57) ABSTRACT

A storage unit comprising: a plurality of locations, each location capable of receiving and storing an item; and at least one machine readable information unit associated with the storage unit.

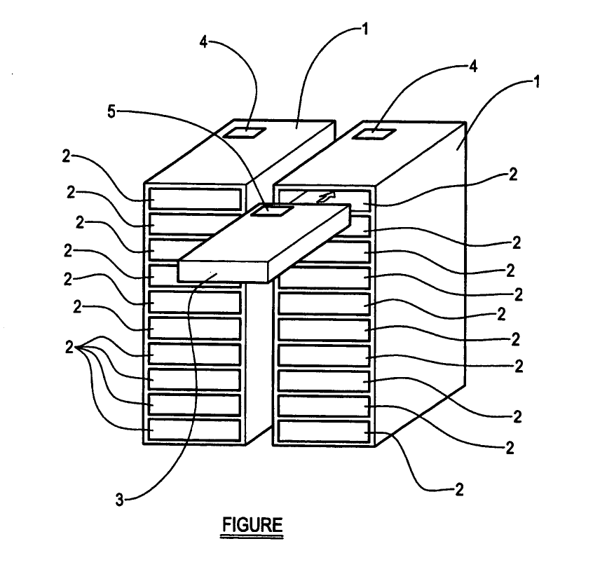

This invention relates to a storage unit and more particularly to a storage unit for storing a plurality of items therein.

Modern tape libraries typically hold their tape cartridges in magazines. Each magazine holds many tape cartridges and typically all tape cartridges are in the same media format. Magazines may be loaded with tape cartridges while outside the tape library and these populated magazines may then be inserted into the library as a unit and similarly removed as a unit. Such magazines provide a way to reduce the time necessary to populate and depopulate the library and also provide an easy and convenient way to keep data sets of cartridges together once outside the library.

Keeping track of the data stored on tape cartridges in a large tape library can be a difficult and time consuming task. An inventory can be carried out which, at its most basic, involves the library loading each separate tape cartridge into a tape drive, in turn reading the table of contents from that tape cartridge (the table of contents usually being provided in media header information at the start of a tape) and then returning the tape cartridge to its magazine. The individual tables of contents must then be collated into a single database and stored in the backup software application running on a controlling host computer - the library controller. This database can then be processed to find existing data sets as requested by the user or by the library and to find blank cartridges or empty magazine slots.

For a large library, the total time taken to make such an inventory of all the tape cartridges can add up to a significant delay before any newly initialised library is ready for operation. This delay is also seen whenever there is a substantial change in the media contents of the library. Typically and cautiously, a library would need to carry out a basic inventory each time the library door is opened, given that the user may have moved, removed or added multiple tape cartridges or magazines.

Barcodes are used and are manually attached to individual tape cartridges. Many modern tape libraries incorporate robotic pickers provided with barcode readers allowing the library to determine quickly which tape cartridges are present. There is, of course, the limitation that a barcode can only carry a relatively small amount of information usually coding just a simple serial number for each cartridge and so the application software must be able to match the serial number to the expected contents of the cartridge. This may give an invalid result if the cartridge has been used in another application and has had its contents modified. There are also mechanical difficulties with barcodes in that the barcode is usually provided as a laminated tablet stuck by self-adhesive to the tape cartridge. The tablets can become unstuck and foul the robotics of the library. Barcodes also become worn and dirty over time and can become difficult to read or at least read accurately. There is also the requirement that each barcode is necessarily given a unique identifier.

Cartridge memories are now also being used in modern tape cartridges comprising a solid-state memory chip embedded in or attached to tape cartridges. The LTO and AIT formats offer cartridge memories. The memory is much faster to read than the time taken to load the cartridge and read the beginning of the tape so the media header information and other information relating to the data held on the tape cartridge can be readily stored in the solid-state memory. It should be noted in this regard that instead of a barcode reader (or in addition thereto), the robotic picker incorporates or carries a cartridge memory reader. Even with the benefit of providing this information in the cartridge memory on the cassette, a still significant time is taken to inventory every single tape cartridge in a large library because of the mechanical movements between the locations of the tape cartridge storage site required of the library robotic picker.

The present invention provides a storage unit comprising: a plurality of locations, each location capable of receiving and storing an item; and at least one machine readable information unit associated with the storage unit.

In order that the present invention may be more readily understood, embodiments thereof will now be described, by way of example, with reference to the accompanying FIGURE which is a perspective view of a number of storage units embodying the present invention.

Referring to the FIGURE, a storage unit in the form of a tape cartridge magazine 1 embodying the present invention comprises a plastics moulding having a plurality of slots 2 or bays within each of which is to be stored a tape cartridge 3 of a given media format. The magazine 1 is sized to provide the requisite number of slots 2 or bays for the requisite number of tape cartridges 3 and dimensioned accordingly. In most respects, the magazine 1 embodying the present invention is identical to a conventional tape library magazine. However, the magazine 1 embodying the present invention incorporates a memory device 4 such as a solid-state memory device on or in the plastics moulding of the magazine 1. The memory 4 is preferably part of a passive RF transponder and is readable and writable.

In a tape library, a plurality of such magazines 1 are used to store tape cartridges 3. The magazines 1 are also used as a convenient means for storing tape cartridges 3 outside of the tape library in a storage location.

As discussed in the background section it is known to provide cartridge memories 5 and readers to read out the information contained in the cartridge memory 5 and to position the cartridge memory 5 on or in a tape cartridge 3. The memory device 4 is positioned on the magazine 1 to allow it to be read by a cartridge memory reader as carried on a conventional library robotic picker which comprises a conventional part of the library infrastructure. Thus, the ideal location for the memory device on the magazine 1 is near or in an equivalent location to the location of the cartridge memories found on the cartridges, when the cartridges are stored in their respective slots in the magazine 1 as shown in the FIGURE. Such positioning minimises the movements required by the library robotic picker to place the reader in a position in which it is capable of reading the memory device 4. Typically, cartridge memories are positioned on the top surface of the cartridge near the back of the cartridge (i.e. towards the front of the magazine when the cartridge is inserted in the magazine—cartridges being inserted front first into the magazine). A minor modification to a conventional magazine 1 allows the memory device for the magazine to be positioned on a plate either above, below or between the cartridges, which plate protrudes to leave the memory device 4 in a position which is aligned with the cartridge memories.

The picker mounted reader is operable to read the information stored in the cartridge memory 5 of a tape cartridge 2 in each particular slot. The reader is connected by a microprocessor, preferably the library controller, to the magazine memory device 4—that connection can be a wired or a wireless connection. In this manner, information read from the cartridge memories 5 is used to update the inventory information held in the magazine memory device 4. The connection between the magazine memory device 4 and the other components of the library such as the library controller is preferably wireless to allow the magazine 1 to be readily removed from the library and replaced by a similar magazine.

For the purposes of data tracking, the provision of a memory device 4 on the magazine is extremely advantageous. For example, incorporating a memory device 4 in a magazine 1 allows a library controller of the tape library or other central unit to monitor which tapes are located in which magazine. In this regard, the magazine memory device 4 stores the contents of the magazine 1 as individual tape cartridge serial numbers as provided on the tape cartridge memories. The memory device 4 can also include further information such as media header information taken from each of the tape cartridge memories. Individual magazines can also be tracked and their location logged—something which is especially useful when magazines 1 are being removed from the library for storage for time periods outside the library.

The data set for overnight backup operations often run over a single tape and therefore span multiple tapes. Having a single magazine in which all these tapes are stored allows the data set to be kept intact for storage purposes, the memory device 4 storing information such as the tape cartridge serial numbers and the content information for each of the tape cartridges.

Whilst on the subject of tracking tapes, it should be noted that tapes are often stored by third parties away from the tape library. A single customer's tapes are usually stored in the same place and the ability to identify a batch of tapes rather than individual tapes is of assistance, especially if a batch of tapes relates to a single data set stored in a single magazine.

Savings can also be made with regard to inventory times. Since the magazine memory device 4 can store details of all the tape cartridges within the magazine, only the magazine memory device 4 need be interrogated to determine the contents of the magazine rather than having to interrogate each of the tape cartridge memories. Further savings can be made to inventory times by utilising a library or magazine equipped with slot specific readers, i.e. a magazine fitted with a reader associated with each slot in the magazine. The slot readers are operable to read the information stored in the cartridge memory 5 of a tape cartridge 2 in a particular slot. Each slot reader is in turn connected by a microprocessor to the magazine memory device 4—that connection can be a wired or a wireless connection. In this manner, information read from the cartridge memories 5 is used to update the inventory information held in the magazine memory device 4 without the need for a reader carried on the mobile picker to move to and interrogate each cartridge memory 5 for each tape cartridge 2 in the magazine.

The magazine memory device 4 has a larger storage capacity than a cartridge memory. The larger the storage capacity, the more information about the cartridges in the magazine can be stored on the magazine memory device 4. It is envisaged that the magazine memory device 4 storage capacity would be in the order 4 to 8 kilobytes enabling not just tape cartridge identifiers and a table of contents to be included in the magazine memory but also a history of tape cartridges which have been located in the magazine 1. It could also duplicate the data on each of the cartridge memories 5 for the tape cartridges 4 held in the magazine.

For larger infrastructures comprising many tape libraries each having many magazines, it is also envisaged that a memory device or the like can be associated with each tape library. Again, issues such as inventory times are improved since the tape library memory can include information relating to the magazine contents or tape contents of the magazines or tapes stored therein. In this regard, the situation is analogous to the library itself being considered as a magazine and the magazines comprising part of the library being considered as the items being stored in the magazine.

On top of the shorter inventory times, enhancements to the controlling software can utilise the association of a memory device 4 with a magazine to deliver further value. For instance, this technology delivers the ability to track a set of cartridges that have a logical relationship with each other, such as containing the data from a single day's snapshot data backup. This is particularly valuable where the cartridges are inter-dependent, such as when a data backup session spans more than one tape across cartridge boundaries. In this case it is necessary to keep the cartridges together in case it is necessary to restore the session. While the cartridges are in the magazine, that should not be a problem, but if they become separated, then the memory device 4 stores the cartridge identifiers that were originally in the magazine so that the tape cartridges can be found and reunited to allow the data set or session to be completed.

When out of the library, conventional magazines are either tracked by the human readable labels on the cartridges they contain, which is time consuming when there are, say, ten cartridges per magazine, or tracked by a barcode or similar machine readable information on the magazine, which requires access to a separate database to decode any data associated with the magazine. The magazine 1 embodying the present invention enables any user with a handheld reading device such as an RF reader quickly to read all the data stored in the magazine memory device 4 and so get a rapid display of the contents of the magazine, that information relating to the identity or contents of each tape cartridge in the magazine being stored in the magazine memory device 4 and derived from the cartridge memories of the stored tape cartridges.

In the above examples, the items to be stored in the storage units, the magazines, comprise tape cartridges. The invention is, however, applicable to other items and their storage units be they configured as magazines, shelf units, racking or juke-box style storage units. The items are not restricted to tape media and can comprise disks, memory devices or other items which do not themselves store data.

In the present specification “comprises” means “includes or consists of” and “comprising” means “including or consisting of”.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A storage unit comprising:
a plurality of locations, each location capable of receiving and storing an item; and
at least one machine readable information unit having a memory device that is readable and writeable by wireless communication.

2. A storage unit according to claim 1, wherein the memory device is a solid state memory device.

3. A storage unit according to claim 1, wherein the at least one machine readable information unit is located at a position on the storage unit so as to be readable by a reader operable to read a machine readable information unit of an item stored in one of the plurality of locations.

4. A storage unit according to claim 1, wherein the storage unit is a magazine and the items are digital data storage devices.

5. A storage unit according to claim 1, wherein each item to be stored in the storage unit carries identification information and the at least one machine readable information unit includes at least the identification information of each of the items stored in the storage unit.

6. A storage unit according to claim 5, wherein the at least one machine readable information unit further includes content information concerning the content of each of the items stored in the storage unit.

7. A storage unit according to claim 1, wherein the items are tape cartridges, each tape cartridge having a cartridge memory including data, and wherein the at least one machine readable information unit includes at least an extract of the data included on the cartridge memory of each of the tape cartridges stored in the storage unit.

8. A storage unit according to claim 1, further comprising a plurality of readers connected to the at least one machine readable information unit, each reader being associated with a location of the storage unit and being operable to read information included in a machine readable information unit of an item stored in the location, and the at least one machine readable information unit includes information based upon information read by the readers.

9. A storage unit according to claim 8, wherein the readers are connected to the at least one machine readable information unit by a wireless connection.

10. A storage unit comprising:
a plurality of locations, each location capable of receiving and storing an item; and
at least one machine readable information unit including information regarding items stored in the storage unit, the information included in the at least one machine readable information unit being readable by wireless communication.

11. A storage unit according to claim 10, wherein the at least one machine readable information unit includes a memory device that is readable and writeable by wireless communication.

12. A storage unit comprising:
a plurality of locations, each location capable of receiving and storing an item; and
at least one transponder including information regarding items stored in the storage unit, the information included in the transponder being readable by wireless communication.

13. A storage unit according to claim 12, wherein the at least one transponder includes a readable and writeable memory.

14. A storage unit comprising:
a plurality of locations, each location capable of receiving and storing an item;
at least one machine readable information unit having a memory device that is readable and writeable by wireless communication; and
a plurality of readers connected to the at least one machine readable information unit, each reader being associated with a location of the storage unit and operable to read information included in a machine readable information unit of an item stored in the location, and the at least one machine readable information unit includes information based upon information read by the readers.

15. A storage unit according to claim 14, wherein the readers are connected to the at least one machine readable information unit by a wireless connection.

16. A storage structure incorporating one or more storage units according to claim 1.

17. A digital data storage device magazine comprising:
a plurality of locations, each location capable of receiving and storing a digital data storage device; and
at least one machine readable information unit having a memory device that is readable and writeable by wireless communication.

18. A magazine according to claim 17, wherein each digital data storage device to be stored in the magazine carries identification information and the at least one machine readable information unit includes at least the identification information of each of the digital data storage devices stored in the magazine.

19. A magazine according to claim 18, wherein the at least one machine readable information unit further includes content information concerning the content of each of the digital data storage devices stored in the magazine.

20. A digital data storage device library incorporating one or more digital data storage device magazines and a mobile reader, each magazine comprising:
a plurality of locations, each location capable of receiving and storing a digital data storage device having a machine readable information unit; and
at least one machine readable information unit having a memory device that is readable and writeable by wireless communication,
wherein the mobile reader is operable to read machine readable information units of digital data storage devices stored in the magazines and the at least one machine readable information unit of each magazine.

21. A library according to claim 20, wherein each digital data storage device to be stored in the magazines carries identification information and the at least one machine readable information unit of each magazine includes at least the identification information of each of the digital data storage devices stored in the magazine.

22. A library according to claim 21, wherein the at least one machine readable information unit of each magazine further includes content information concerning the content of each of the digital data storage devices stored in the magazine.

23. A library according to claim 20, wherein the at least one machine readable information unit of each magazine is based upon information included in the machine readable information units of digital data storage devices stored in the magazine.

24. A method of taking an inventory of the digital data storage devices in a digital data storage device library having one or more digital data storage device magazines, each magazine comprising: a plurality of locations, each location being capable of receiving and storing a digital data storage device; and at least one machine readable information unit including at least the identification information for each of the digital data storage devices stored in that magazine, the method comprising: wirelessly interrogating the machine readable information unit of the or each magazine to obtain an inventory of the digital data storage devices in the or each magazine.

25. A method according to claim 24, wherein the at least one machine readable information unit further includes content information concerning the content of each of the digital data storage devices stored in the magazine, the method further comprises supplementing the inventory of the digital data storage devices with a content inventory.
